(19) United States
(12) Patent Application Publication
(10) Pub. No.: US 2024/0119068 A1
(43) Pub. Date: Apr. 11, 2024

(54) SYSTEM AND METHOD FOR REAL-TIME DATA CATEGORIZATION

(71) Applicant: Incucomm, Inc., Addison, TX (US)

(72) Inventor: Christopher Scott Heinlen, Dallas, TX (US)

(73) Assignee: Incucomm, Inc., Addison, TX (US)

(21) Appl. No.: 18/475,963

(22) Filed: Sep. 27, 2023

Related U.S. Application Data
(60) Provisional application No. 63/377,278, filed on Sep. 27, 2022.

(51) Int. Cl. G06F 16/28

(52) U.S. Cl. CPC G06F 16/287

(57) ABSTRACT

System and method for real-time data categorization of streaming data output from a data collection system, wherein the categorization system and method has no initial knowledge of a plurality of data categories to which ones of the data in the streaming data can be assigned, each of the plurality of data categories associated with a data cluster. The system, and corresponding methodology, are operative to check each one of the data, as received, against any known data categories and, if one of the data fits one or more of the known data categories, classifying the one of the data according to the one or more of the known data categories, otherwise adding the one of the data to a pool of unclassified data; execute, when the pool of unclassified data reaches a threshold, an unsupervised clustering method on the pool to identify any previously uncategorized clusters of data and define one or more new data categories for any such previously uncategorized clusters; use, if a new data category is defined for a previously uncategorized cluster of data, each of the previously uncategorized clusters to define a shell for which previously unclassified data can be checked for inclusion and assigning any such unclassified data within the shell to the new data category; and, output the categorized data to a data analysis system.

### CROSS-REFERENCE TO RELATED APPLICATION

This application claims the benefit of U.S. Provisional Patent Application Ser. No. 63/377,278, filed on Sep. 27, 2022, entitled “An Improved Method for Unsupervised, Noisy-Data-Stream Clustering:”, the disclosure of which is incorporated herein by reference.

### TECHNICAL FIELD

The present disclosure is directed, in general, to real-time data categorization and, more specifically, to systems and methods for dynamically categorizing streaming data output from a data collection system, wherein said categorization system has no initial knowledge of a plurality of data categories to which ones of said data in said streaming data can be assigned.

### BACKGROUND

Artificial Intelligence and Machine Learning (AI/ML) techniques are generally brittle; that is, they are prone to failure if there are any discrepancies between training and application. This means that an AI/ML technique may perform well when analyzing a discrete data set, but that performance will fall apart when new data is added to the model. This degradation is apparent when new data belonging to existing categories is injected into the model but is even more pronounced when a new type of data, previously unseen, is added to a model. Because of this, traditional AI/ML solutions generally need to be retrained if a new category of data is added to the system. Additionally, many AI/ML solutions do not have a mechanism to detect outliers or noise; instead, they force such data points into categories they do not belong to.

Accordingly, there is a need in the art for systems and methods that overcome those deficiencies; in particular, there is a need in the art for systems and methods for real-time data categorization designed to handle streaming, infinite data sets and to dynamically add new classification types as new data types are seen.

### SUMMARY

To address the deficiencies of the prior art, disclosed hereinafter are a system and corresponding methodology for real-time data categorization of streaming data output from a data collection system. The categorization system and method can categorize data even when there is no initial knowledge of data categories to which ones of the data in the streaming data can be assigned, wherein each of the plurality of data categories is associated with a data cluster. The system, and corresponding methodology, are operative to check each one of the data, as received, against any known data categories and, if one of the data fits one or more of the known data categories, classifying the one of the data according to the one or more of the known data categories, otherwise adding the one of the data to a pool of unclassified data; execute, when the pool of unclassified data reaches a threshold, an unsupervised clustering method on the pool to identify any previously uncategorized clusters of data and define one or more new data categories for any such previously uncategorized clusters; use, if a new data category is defined for a previously uncategorized cluster of data, each of the previously uncategorized clusters to define a shell for which previously unclassified data can be checked for inclusion and assigning any such unclassified data within the shell to the new data category; and, output the categorized data to a data analysis system.

In one embodiment, the shell is defined by a closed surface and inclusion of data within the shell is determined as a function of whether the location of the data is within the closed surface. In an exemplary embodiment, the shell is defined by an equation in spherical coordinates, and inclusion of data within the shell is determined as a function of evaluating the equation for each of the unclassified data to determine if its location is within the radius defined by the equation.

The system, and corresponding method, can further comprise means, or a step, for generating a representative group of points for the shell that occupies a spatial region that encompasses the previously uncategorized cluster. In an exemplary embodiment, the means, or step, for generating a representative group of points utilizes vector quantization. A related embodiment further includes determining one or more distance thresholds that are a function of the relative spacing between ones of the representative group of points and the previously unclassified data within the shell. Ones of the previously unclassified data can be determined to be within the shell if a distance between any such data and each of the points comprising the representative group of points is within a threshold associated with each of the points comprising the representative group of points.

The system, and corresponding method, can further comprise means, or a step, for performing a second characterization pass on the streaming data, the second characterization pass operative to reevaluate any newly-identified clusters and the inclusion of any of the data therein. The second characterization pass can be performed periodically as the streaming data is received; alternatively, it can be performed subsequent to a streaming data collection period. The second characterization pass can be further operative to merge neighboring clusters into one category or split clusters that contain at least two distinct data categories.

In exemplary embodiments, the threshold for the pool of unclassified data is a function of the data rate of the streaming data. The threshold can further be a function of a predefined temporal interval.

In one embodiment, the unsupervised clustering method utilizes Delaunay triangulation. Alternatively, the unsupervised clustering method utilizes a Parzen Window Density Estimation (PWDE) defined by the equation:

$$p ( x ) = \frac{1}{n} {\sum }_{i = 1}^{n} \frac{1}{V} ϕ ( \frac{{x}_{i} - x}{h} )$$

wherein ϕ is a window function, h is the window width, V is the volume of the window, n is the number of points in the data set, x is location at which the density estimation is evaluated at, and xᵢ are the points in the data set.

The categorization system and method can be used in a variety of applications. In one exemplary application, the data collection system is associated with a radar system; in a related exemplary application, the data analysis system is operative to utilize the categorized data to identify radar pulses.

The foregoing has broadly outlined the essential and optional features of the various embodiments that will be described in detail hereinafter; the essential and certain optional features form the subject matter of the appended claims. Those skilled in the art should recognize that the principles of the specifically disclosed embodiments and functions can be utilized as a basis for similar systems and methods that are within the scope of the appended claims.

### BRIEF DESCRIPTION OF THE DRAWINGS

For a more complete understanding of the present disclosure, reference is now made to the following detailed description taken in conjunction with the accompanying drawings, in which:

FIG. 1 illustrates four categories of concept drift for streaming data;

FIG. 2 illustrates a real-time data categorization system according to the principles of the invention;

FIG. 3 illustrates Delaunay triangulation of an exemplary data cluster and noise;

FIG. 4 illustrates an exemplary two-dimensional point set and its resulting Parzen Window Density Estimation;

FIG. 5 illustrates exemplary unsupervised clustering of 3-dimensional data;

FIG. 6 illustrates exemplary cluster bridging; and,

FIG. 7 illustrates an exemplary shell and corresponding data points.

Unless otherwise indicated, corresponding numerals and symbols in the different figures generally refer to corresponding parts or functions.

### DETAILED DESCRIPTION

The system and method described hereinafter overcome certain deficiencies of the prior art; in particular, the system and corresponding method are designed to handle streaming, infinite data sets and to dynamically add new classification types as new data types are seen. The methodology is not limited to a certain number of classification types and does not need to be retrained as new data types are introduced; thus, making it efficient and adaptable. Additionally, it can detect outliers and noise and categorize them as such.

There are three overarching branches of machine learning which dictate how data is processed: supervised, unsupervised, and reinforcement learning. Supervised learning is a model created with data whose input and output are known. Supervised learning can be broken down into regression techniques for continuous response prediction and classification techniques for discrete response predictions. Unsupervised learning deals with unknown data and employs clustering techniques to identify patterns within the data; this type of learning can be broken down into hard clustering and soft clustering. Hard clustering puts each data point into one, and only one, cluster while soft clustering can assign a data point to multiple clusters. Finally, a reinforcement learning model is trained on successive iterations of decision-making, with rewards given based on the results of those decisions.

Traditional machine learning deals with a static data set, but there are many use cases which necessitate the ability to classify data points within an endless data stream. Streaming data, as opposed to a static data set, presents distinct challenges for data classification. One such challenge is concept drift which is described in Data Stream Clustering: A Review by Zubaroğlu, A. and Atalay, V., (2020) (see: https://doi.org/10.48550/arXiv.2007.10781). Concept drift is a change in the properties or features within a data stream over time, which can be broken down into four categories: sudden, gradual, incremental, and recurring.

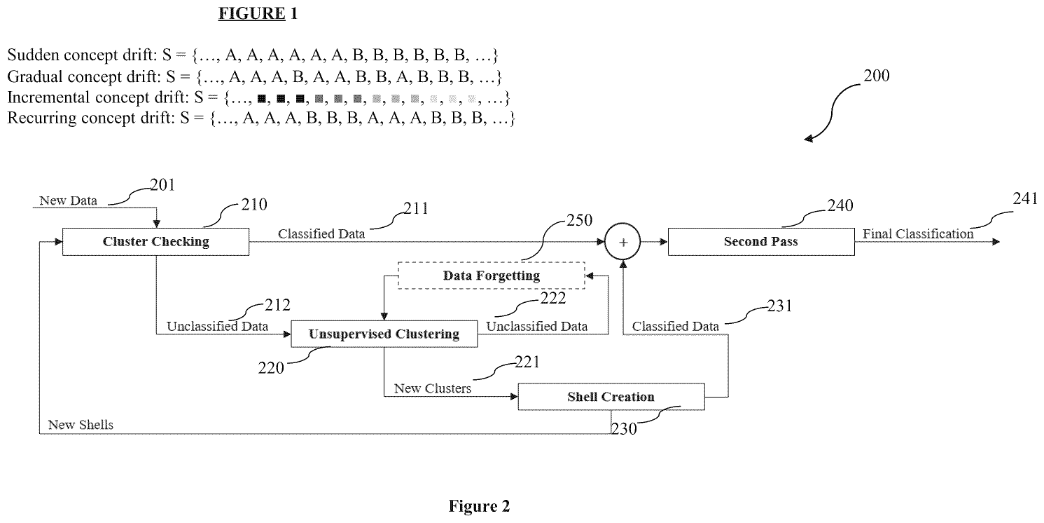

FIG. 1 illustrates the four categories of concept drift for streaming data: sudden, gradual, incremental and recurring concept drift. To understand each of these types of drift, consider a data stream S comprised of data points with features A and features B. As illustrated in FIG. 1, sudden concept drift is a feature change that occurs instantaneously between two neighboring data points in time; before and after the change the features present in the data are static. As also illustrated in FIG. 1, gradual concept drift occurs when two distinct feature sets are present in the data; the first feature set A is initially present by itself but over time the second feature set B becomes interspersed in the incoming data until eventually the second feature set is the only feature present.

Next, incremental concept drift describes a slow change from one feature set to another; this change occurs incrementally from one data point to the next as the original feature set morphs into a completely different feature set. As illustrated in FIG. 1 for incremental concept drift, consider a data stream initially consisting of data points with a black feature and, after a period of time, the data stream consists of a light grey feature. During the transition from black to light grey, the data points will be comprised of a combination of the starting feature and the ending feature causing the data points to gradate from black to light gray. Finally, recurring concept drift refers to two distinct feature sets A and B switching between themselves over time, neither disappearing completely from the data stream and each returning in turn.

The system and related methodology described herein innovatively utilizes soft, unsupervised clustering to classify streaming data without the need for any prior knowledge of the data, including the number of classification types within the data stream. Additionally, because the classification types are dynamic, the disclosed system/methodology—unlike prior art systems and methods—can overcome issues stemming from concept drift.

There are a plurality of applications in which the disclosed system and related methodology can be advantageously employed. For example, the disclosed real-time data categorization system/methodology can be used to identify radar pulses in real time, without knowledge of the type of pulses that are present or can be applied to financial data to find anomalies or to find and track the occurrence of a specific transaction type. The disclosed system/methodology can also be utilized for real time analysis of data collected from any type of sensor and behavior changes or anomalies could be automatically found. Similarly, the system/methodology can be applied to communication data for behavioral analysis. In general, the disclosed system and related methodology can easily be applied to any streaming data with discrete data instances containing some number of features, and can dynamically classify those instances into categories or flag them as an outlier.

The disclosed system/methodology is capable of being coupled with a data streaming system like Lone Star Analysis' AOS Edge Analytics, disclosed in U.S. patent Ser. No. 10/795,337, which issued on Oct. 6, 2020. AOS Edge Analytics provides an infrastructure for data to be captured and streamed, and this infrastructure can be utilized to feed the data to the system/methodology disclosed herein. Additionally, the disclosed system/methodology is closely tied to Lone Star's Correlated Histogram Clustering (CHC) methodology, as disclosed in U.S. patent application Ser. No. 17/808,093, filed on Jun. 21, 2021, in that both are novel methods of unsupervised clustering. The distinction in utility between CHC and the system/methodology disclosed herein is that CHC analyzes a static data set and determines cluster centroids while the method disclosed herein analyzes streaming data and determines cluster membership of individual data points. Lone Star's Evolved AI™, as disclosed in United States Patent Publication No. 2020/0193075, dated Jun. 18, 2020, is also related to the system/methodology disclosed herein in that both are explainable and transparent approaches to artificial intelligence. Additionally, these solutions don't require massive data lakes, nor do they rely on many-layered neural networks to make decisions. Evolved AI™ systems and methods employ stochastic non-linear optimization.

One embodiment of the disclosed system/methodology, which will be further elaborated later herein, relies heavily on Delaunay triangulation. Delaunay triangulation is a specific triangulation method which creates connections between points in a point set. To explain what a triangulation is, De Loera defines a few concepts first:
A Point Configuration is a finite set of points A={a₁, . . . , aₙ} that exist in [symbol] ^{d}.
The Convex hull of A, conv(A), is the intersection of all convex sets containing the points in A.
A simplex is the simplest possible polytope (flat sided geometric object) in n-dimensions; a 0-simplex is a point, a 1-simplex is a line segment, a 2-simplex is a triangle, a 3-simplex is a tetrahedron, and so on. Formally, a k-simplex is the convex hull created from k+1, affinely independent, vertices. Affinely independent refers to a set which, when one member is subtracted from the set, becomes linearly independent. A k-simplex is comprised of a number of j-faces which are themselves simplices consisting of j+1 vertices. A j-face can be any simplex from −1, an empty set, to k.
   Given those definitions, a triangulation of A in [symbol] ^{d} can be defined as a finite collection of d-simplices of A that satisfy the two requirements:
1. The union of the simplices is equal to conv(A); and,
2. Any two simplices intersect in a common face (possibly empty).
   For most sets there are multiple possible triangulations; the triangulation method described herein is the Delaunay triangulation, which for any given set of points has just a single triangulation. The specifics of Delaunay triangulations are further described later herein.

Triangulations are a subset of tessellations and have many different applications. They are typically used to generate meshes and can be applied in the fields of 3D modeling, finite element analysis, terrain mapping, and path planning, amongst others. For the system/methodology described herein, it is used as a way of determining a point's neighbors without predefining the number of neighbors that point has. A traditional method of defining neighbors is k-nearest neighbors which defines a point's neighbors as the k closest other points; the drawback to this method is that every point will not necessarily have the same number of relevant neighbors. By using Delaunay triangulation, a point's neighbors can be defined as the points that are vertices of a common simplex; thus, the number of neighbors a point has is dynamic and depends on the geometry of the point set. This is advantageous because a point in the middle of a cluster may have more relevant neighbors than a point on the exterior of a cluster.

While the embodiments described herein utilize Delaunay triangulation, other triangulation or tessellation techniques could be used. If a scale invariant tessellation was utilized, that feature could be leveraged to find locations of interest on a macro level; further analysis could then be performed on these locations of interest. This method of zooming in on areas of interest, or selective analysis, would be beneficial for problems with high dimensionality and large search spaces. By being discerning about where a full analysis is performed, computation times can be reduced.

FIG. 2 illustrates a real-time data categorization system 200 according to the principles of the invention; the system, and corresponding methodology, can dynamically categorize streaming, noisy data without prior knowledge of what categories or how many categories exist within the input data (“New Data”; 201). Unlike many prior art approaches, the system 200 does not force every data point into a category and is therefore especially useful when analyzing noisy data as it allows a data point to be classified as noise. The system 200 can be configured down into four distinct modules/functions (210, 220, 230, 240) which work in tandem to categorize incoming data 201 and create new category buckets as they appear in the data, yielding a final classification 241 for all input data. The system 200, including each of the means 210, 220, 230 and 240, can be implemented in one or more processors and memories, wherein the one or more memories contain instructions which, when performed by the one or more processors, are operative to perform the functions disclosed hereinafter.

First, the system 200 comprises means 210 for checking each one of said data (“New Data”; 201), as received, against any known data categories and, if said one of said data fits one or more of said known data categories, classifying said one of said data according to said one or more of said known data categories (“Classified Data”; 211), otherwise adding said one of said data to a pool of unclassified data (“Unclassified Data”; 212). More particularly, means 210 is operative to, for each new data point 201 entering the system 200, test the new data point against existing data categories; such categories may be predefined or learned from previous input data. The means/method of testing will depend on how a shell is defined by the means/method for shell creation 230 described hereinafter. One embodiment is to use a node-based definition in which nodes are created in the general area of the cluster and then defined as being included or excluded from the shell. In such embodiments, each incoming data point is transformed into each existing cluster's nodal space and then checked for cluster inclusion. The creation of this nodal space will be explained in more detail hereinafter. Shells can be defined in a plurality of ways, but regardless of how the shell is defined it will have a method of checking for inclusion, and that check will be the first step for any new data 201 entering the system 200. In one embodiment, a shell could be defined by an equation in spherical coordinates; a new data point would be checked for inclusion by evaluating the equation at the new data point and determining if the data point's radius is within the radius defined by the equation. Another potential embodiment would be to use a surface to define the shell; by checking whether a point falls inside or outside of that surface cluster, inclusion can be determined. After this check, the new data point will either be categorized as belonging to an existing cluster or not. A point can potentially belong to multiple clusters because categories are defined independently. This independence can result in multiple clusters overlapping. This is intentional and the means for a second pass described hereinafter, in part, tries to reconcile any such overlaps. In the case that a point does belong to a cluster, that will be reported; in the case that it does not, it gets added to a pool which will go on to the means for unsupervised clustering 220 portion of the system.

Next, the system 200 comprises means 220 for, when said pool of unclassified data 212 reaches a threshold, executing an unsupervised clustering method on the pool of data to identify any previously uncategorized clusters of data and define one or more new data categories for any such previously uncategorized clusters (“New Clusters”; 221); if a new category, or cluster, is found, the new cluster 221 is input to a means to define a shell (“Shell Creation”; 230) with which subsequent new data 201 can be checked against to determine inclusion.

More particularly regarding means 220 for executing an unsupervised clustering method, when the pool of unclassified data 212 reaches a predetermined threshold, the system 200 will attempt to find new clusters within those data points. The threshold can be a function of the streaming speed of the incoming data and how often the user wants to check for newly forming clusters; i.e., the threshold can be a function of the data rate of the streaming data and, if desired, a function of a predefined temporal interval. The unsupervised clustering method can be applied to high dimensional data but, for the ease of visualization, will be described herein with respect to two- and three-dimensional examples. The means 220 for executing an unsupervised clustering method does not need any prior knowledge of the input data 201 and returns groupings, or clusters, of like data within the complete set. While this form of unsupervised clustering does not depend upon prior knowledge, in the case where the user does have prior knowledge, additional thresholds and discriminators can be added to the process. Additionally, the unsupervised clustering method can isolate clusters from surrounding noise so that every point need not belong to a found cluster. Identifying clusters within the data is critical as it allows the system to categorize data by type and isolate relevant data from noise.

In one embodiment of the means 220 for executing an unsupervised clustering method, the first step is determining the distances between each point and its neighbors in the data set. There are a plurality of distance metrics that could be used and, depending on the data set, different distance metrics may yield better or worse results. The most straight-forward metric is Euclidean distance, in which the differences between the features of two data points are squared and summed and the distance between the two points is the square root of that sum:

$$d ( p , q ) = \sqrt{{\sum }_{i - 1}^{n} {( {q}_{i} - {p}_{i} )}^{2}}$$

Determining what constitutes a neighbor is another aspect of the method in which a plurality of approaches could be taken; the exemplary embodiment described here uses Delaunay triangulation. In two dimensions, Delaunay triangulation is a triangulation method for a set of discrete points in which the resulting circumcircles of the created triangles contain only the points at the vertices of the triangle and no other points from the data set. By using this method, the resulting triangles have interior angles whose minimum is maximized, and maximum is minimized; this makes the triangles tend towards being as close to equilateral as possible. The process, however, is not limited to two dimensions—by using simplices instead of triangles and circum-hyperspheres instead of circumcircles, the Delaunay triangulation is unlimited and can be determined in n-dimensions. This is significant because the methodology disclosed herein is not constrained to only analyzing two-dimensional data, but can be applied to data with many features.

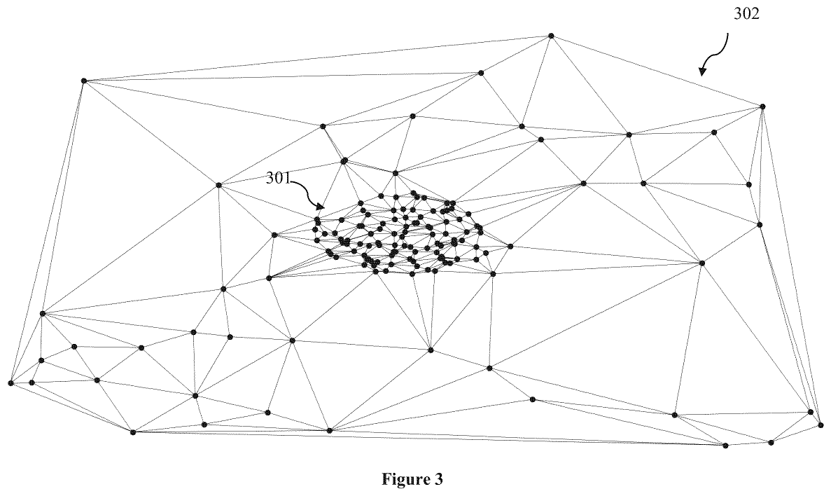

Turning now FIG. 3, illustrated is Delaunay triangulation of an exemplary data cluster and noise; more specifically, a two-dimensional point set and its resulting Delaunay triangulation. The data points are represented as black dots and the edges of the triangles as lines therebetween. The exemplary data set contains a tightly packed cluster 301 surrounded by noise points 302. The triangles within the cluster are much more compact than those in the noise areas; this difference in size, specifically the difference in edge length, is what unsupervised clustering means 220 uses to easily determine whether or not a cluster exists within a data set.

Each point in a dataset will be part of one or more simplices defined by Delaunay triangulation and the points on the other vertices of these simplices are considered to be the original point's neighbors. With a distance metric and defined neighbors, the distances between every neighbor can be calculated and aggregated. The distances can then be histogrammed to determine the most prevalent neighbor spacing in the data. If the input data 212 is pure noise, the histogram would be expected to follow a Gaussian distribution. If a cluster exists in the data, however, the histogram will show a peak at the distances within the cluster and if noise is present, the overall histogram will skew right. This is due to the noise generally being spread further apart than the points within a cluster. Additionally, if there are multiple clusters, each with their own densities, the histogram will result in a multi-modal distribution with peaks corresponding to each of the clusters. Based on the location of the peak(s) of the histogram and the spread associated with that peak, a threshold distance, or multiple thresholds in the case of a multimodal distribution, can be easily determined to identify clusters and classify points.

In an alternative embodiment of unsupervised clustering means 220, Parzen Window Density Estimation (PWDE) is used to determine the distance threshold. The PWDE is defined with the following equation:

$$p ( x ) = \frac{1}{n} {\sum }_{i = 1}^{n} \frac{1}{V} ϕ ( \frac{{x}_{i} - x}{h} ) ,$$

where ϕ is a window function, h is the window width, V is the volume of the window, n is the number of points in the data set, x is location at which the density estimation is evaluated at, and xᵢ are the points in the data set. The simplest PWDE uses a hypercube as the window, in this case V=h^{d}, where d is the number of dimensions the data set contains; while a hypercube provides a simple PWDE implementation, the window function is not restricted to a hypercube and can take on any geometry.

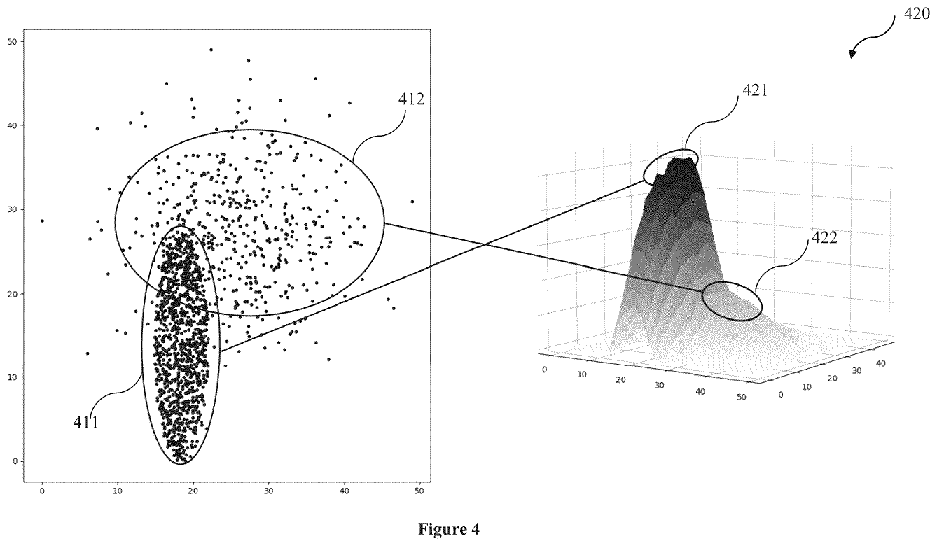

Now referring to FIG. 4, illustrated is an exemplary two-dimensional point set 410 and its resulting Parzen Window Density Estimation 420; the point set 410 contains two overlapping clusters 411, 412 with different densities. The peak 421 of the PWDE 420 can be used to determine a distance threshold capable of defining the dense cluster 411. Additionally, there is a second lower peak 422 that corresponds to the sparser cluster 412 Similar to the embodiment utilizing histograms, a second threshold can be calculated based off of this second peak that is capable of defining the sparse cluster.

Once a distance threshold (or thresholds) is determined, the classification process begins by choosing an arbitrary point in the data set and determining the distance between itself and each of its neighbors. If any of the neighbors are within the distance threshold, the original point and the close neighbor are considered to be within the same cluster. The close neighbors of the original point are then selected, and their neighbors are evaluated for cluster inclusion. This process is repeated until there are no more neighbors of any of the points in the newly defined cluster that are within the threshold distance. This collection of points is defined as a single cluster. After the cluster is fully defined, another arbitrary, undefined point is selected, and the process is repeated. This continues until all the points in the data set are either defined to be a part of a cluster or are further than the threshold from all their neighbors.

Another embodiment of the cluster generation process considers cluster seeds instead of choosing arbitrary points to begin the clustering process. Consider, for example, the PWDE method of determining thresholds. Each threshold can be associated with a location within the problem space and the location can then be associated with a specific data point within the data being analyzed. The data point(s) associated with the threshold(s) generated can then be used to begin the clustering process, allowing the thresholds to be localized to the spatial region they were defined in. This process allows for a more efficient cluster generation as clusters are generated only around seed points as opposed to the method described previously in which the data set is fully defined.

At this point, there are two parameters that define whether a cluster is worth reporting or not. The first is the minimum cluster size; this parameter sets a baseline threshold for the size of clusters. Any clusters found that are smaller than the minimum threshold are reclassified as noise. The minimum cluster size is set at the user's discretion and serves to quantify the minimum number of occurrences needed to define a new data type. The second is the maximum cluster percent; this parameter is to prevent a dataset that is comprised of only noise from being classified as one large cluster. This parameter is a set percentage and if a cluster is comprised of points that are a greater percentage of the whole dataset than the parameter, the cluster is reclassified as noise. This parameter will generally be close to 1. Additional methods of culling out clusters can be implemented at this stage, depending on if there is any leverageable prior knowledge about the data being analyzed.

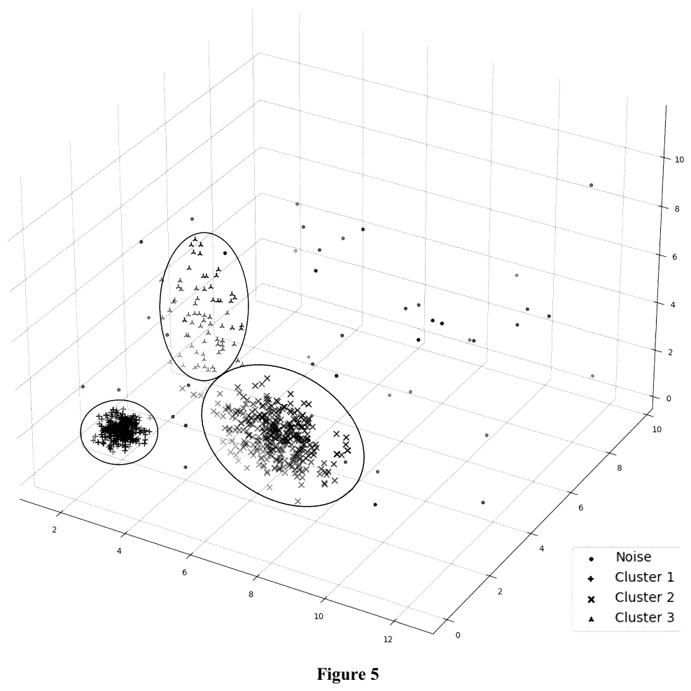

FIG. 5 illustrates the results of running the unsupervised clustering method on a set of three-dimensional data. The data consists of three clusters (represented by “+” for Cluster 1 (501), “×” for Cluster 2 (502), and “∧” for Cluster 3 (503)), all of which have different sizes and densities, and noise points (represented by “•” for Noise). The described means for unsupervised clustering 220 is able to correctly and easily identify all three clusters and assign membership to each of the three clusters, while also identifying the noise points; it is not restricted to a single cluster density, it easily finds cluster three even though it is much sparser than the other two clusters. This difference in density could be a result of a newly appearing data type or a less common data type—in either case, the disclosed means 220 is equipped to identify the cluster.

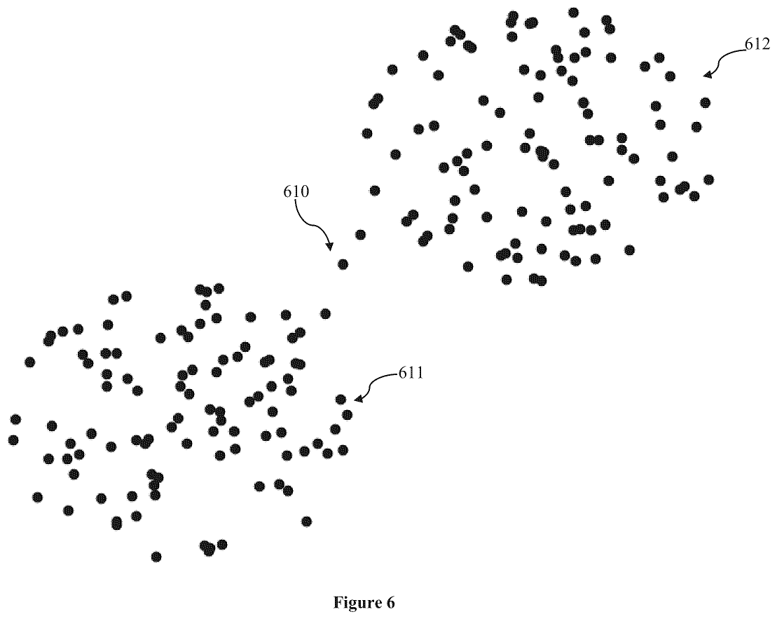

The shell creation process performed by means 220 can be susceptible to bridging between clusters. In an exemplary case illustrated in FIG. 6, bridging occurs when there is a thin band of noisy data points 610 that span between two clusters 611, 612. Because the disclosed method of unsupervised clustering performed by means 220 is just looking at the distance between neighbors, bridging can cause two distinct clusters to merge into a single cluster. Bridging can be successfully combatted in a plurality of different ways. One way is by analyzing local densities to detect bridging. Another way is to look at the shapes of the simplices within the cluster; true members of the cluster will tend to be a part of simplices that are closer to equilateral, while data points that make up a bridge will tend to be members of very thin simplices. Another method of combatting bridging is to analyze the subset of edges from the Delaunay triangulation which are shorter than the distance threshold; points that make up a bridge will be connected to edges whose interior angle will tend towards 180°, and a threshold angle can be set to identify these points. Additionally, the process described hereinafter for the second pass 240 of system 200 will also combat bridging.

Depending on the amount of data being ingested, the length of time the stream is running, and how noisy the data is, means for forgetting 250, or removing, unclassified data 222 may be needed and is easily incorporated into system 200. As the system runs, the unclassified pool will continue to grow as more and more outliers, or noise points, are seen. Left unchecked, the unclassified pool could grow to a size that hampers performance and slows the system, so a method of forgetting may need to be established. The means for functionality can take multiple forms; a simple solution would be a hard cap on either time or size. That is, if a point is older than a threshold, it will be discarded or, if a pool is above a threshold, points will be removed. Alternatively, a soft cap can be implemented, wherein after a certain threshold, either in time or in pool size, a sampling of points is removed as a way of retaining some of the older information in the unclassified pool.

The disclosed unsupervised clustering process performed by unsupervised clustering means 220 is just one of many possible embodiments; this portion of the system 200 could be accomplished with a density-based clustering system, another distance-based system, or any other unsupervised clustering method.

Next, the system 200 comprises means for shell creation 230; more particularly, means for, if one or more new data categories are defined in previously uncategorized data, using each of the previously uncategorized clusters 221 to define a shell for which previously unclassified data 212 can be checked for inclusion and assigning any such unclassified data within the shell to the new data category. Once a new cluster 221 is identified by unsupervised clustering 220, the data points that comprise that cluster 221 are used to create a new shell 232 against which new data points can be compared. As described previously, there are a plurality of ways to define the cluster shell, but an exemplary nodal embodiment is described herein. Delaunay triangulation can be used once again, this time to determine a pseudo-density for a cluster. Using Delaunay triangulation, the median edge distance of the simplices of the cluster can be calculated. If a new point is within that median distance, multiplied by some predefined multiplier, of any point within the cluster, it is likely also a part of the cluster. The predefined multiplier determines how conservative the shell should be. For example, if the multiplier is set to “1”, the shell will only encompass the space that is within the median distance from the points used to originally define the cluster; if the multiplier is set above 1, the boundary of the shell will expand and include more of the surrounding space.

It would be computationally inefficient to calculate the distance of a new point from every point that makes up an existing cluster, so a nodal system is innovatively incorporated within the system 200. The distances can be precomputed, and a new point simply needs to be compared against an existing dictionary of nodes to determine cluster inclusion. The first step in the process is to define a nodal space and create a conversion factor to go between real space (raw feature values) and the cluster's nodal space. This conversion is shown below:
for i in range(point.dimensions):
point[i]=round(((point[i]−x_min[i])*(nodes−1))/x_range[i]),
   where “point” is the data point being converted into the nodal space, “nodes” is the number of nodes in each dimension, “x_min” are the minimum values of the points that make up the cluster in each feature dimension, and “x_range” are the range of values of the points that make up the cluster in each feature dimension. The median edge distance multiplied by the multiplier is subtracted from each “x_min” value and twice that value is added to each “x_range” value so that the entirety of the possible cluster area is included within the nodal space. Finally, the point is rounded to the nearest whole number resulting in a n-dimensional coordinate with values between zero and the number of nodes minus one. By converting from a continuous real space to a discrete nodal space, the inclusion or exclusion of the finite number of nodes can be precomputed; this makes checking new points for inclusion simple and fast.

The points that comprise the new cluster are converted into nodal space without the rounding step and the median edge distance is recomputed within this space. Then, if the minimum distance between a given node and a member of the cluster is less than the median edge distance multiplied by the multiplier, that node is flagged as a part of the cluster. These flagged nodes can be saved to a dictionary with their node space coordinates as keys and a Boolean return to make it easy to quickly determine membership of new data points.

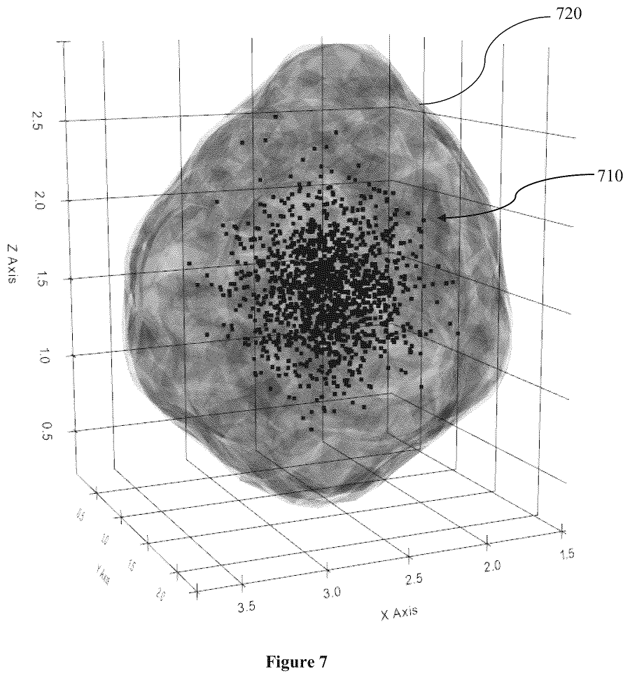

Finally, reference is made to FIG. 7, which illustrates an exemplary shell and corresponding data points. For this example, a three-dimensional cluster of points, represented by the black dots 710, are used to generate a shell 720 using the disclosed methodology; the grey cloud surrounding the points represent the shell created by this system—that is, any new data point that falls within the grey cloud will be identified as belonging to this cluster.

To decrease the time to process a new point, a coarse shell can be implemented before converting a new point to a cluster's nodal space. In the case of a large data set with many categories, it may become time consuming to convert each new data point into every cluster's node space, so a rough check before performing the conversion is useful and compatible. This can be accomplished by comparing the x_min and x_range values in the conversion equation to the data point in real space. If any of the features are less than their corresponding x_min value or greater than their corresponding x_min plus x_range value, then the point will not fall into that cluster and the conversion to nodal space is not necessary. This initial check allows the system to identify new data points more quickly.

An alternative embodiment of the shell creation process performed means 230 is to generate a representative group of points that occupies the same spatial region as the data points that comprise the cluster. Vector Quantization (VQ) is one method of achieving this task, but there are a plurality of methods that could be used to generate the representative points. With a representative group of points, distance threshold(s) can be determined. One version of this embodiment uses a single threshold for the entire shell, but individual thresholds can be created for each representative point. The thresholds can be defined based on the relative spacing of the representative points and the original data points that made up the cluster. Once the representative group and the threshold(s) have been generated, new points can be checked for cluster inclusion by determining the distance of each new data point from each of the representative points; if any of those distances are within the threshold corresponding to the particular representative point, the new data is considered to be a part of the cluster.

Finally, with reference again to FIG. 2, the system 200 can further include means 240 for performing a second characterization pass on the streaming data 211, 231; the second characterization pass is operative to reevaluate any newly-identified clusters and the inclusion of any of the streaming data therein. The method described above will be sufficient to categorize data if the data is separable in the dimensions being analyzed, but that is not always the case. For example, consider two radar signals which are identical in every way except their pulse repetition interval (PRI); analyzing the pulses individually would result in the two signals being classified as the same thing, but analysis can be done on the resulting aggregate to determine that there are two distinct PRIs present in the cluster. Additionally, in the case of very noisy data, a significant amount of noise could be classified as belonging to actual clusters due to spatial proximity; if the actual members of the cluster are related to each other in time, analysis of the aggregate can be helpful in culling out the noise data points that do not actually belong to a cluster.

In cases where it is necessary or useful, a second pass can be utilized, either periodically throughout the data collection or at the end of a data collection period, to reevaluate the clusters generated and the inclusion of points within those clusters; doing so will allow three things:
merging neighboring clusters that should be a single cluster;
splitting clusters that contain two distinct categories; and,
further discriminating noise from data of interest.
   There are a plurality of approaches that could be taken during this step. Features that were left out of the earlier stages can be leveraged, a reduced feature set can be utilized, or simply an analysis of the same feature set within the confines of a single category. The nature of the second pass will depend on the type of data being processed and any prior knowledge about the incoming data.

The time of arrival (TOA) of a data point is a feature that will generally not be useful during the previous steps of the system, but can be leveraged in a second pass. By looking at the TOA of the data points within a given category, similarities in time or the intervals of incoming data points can be analyzed. Outliers can be reclassified as noise and, if multiple distinct groupings form from this analysis, categories can be split. Further, if two neighboring categories share a similar TOA and interval, those categories can be merged.

Comparison of Disclosed Novel Methodology to Existing Systems

Zubaroğlu (id.) succinctly compares existing clustering systems for streaming data in the Table 1 and Table 2; the means and corresponding functionalities described in this document have been added to those tables as “System 200”. The systems described in the tables are Adaptive Streaming k-Means, Fast Evolutionary Algorithm for Clustering Data Streams (FEAC-Stream), Multi Density Data Stream Clustering Algorithm (MuDi-Stream), Clustering of Evolving Data Streams into Arbitrarily Shaped Clusters (CEDAS), Improved Data Stream Clustering, David Boulin Index Evolving Clustering Method (DBIECM), and I-HASTREAM. The novel system is the only system that can find arbitrarily shaped clusters, operate in an online modality, find multi-density clusters, is usable in high dimensions, can find outliers, and does not rely on expert knowledge; these attributes are further explained below.

TABLE 1
Comparison of Data Streaming Classification Methods

| | Base | | | Cluster | Cluster |
|---|---|---|---|---|---|
| System | Algorithm | Phases | Window Model | Count | Shape |
| System 200 | Distance | Online* | None | Auto | Arbitrary |
| | Based | | | | |
| Adaptive Streaming | Partitioning | Online | Sliding | Auto | Hyper- |
| k-Means | Based | | | | spherical |
| FEAC-Stream | Partitioning | Online | Damped | Auto | Hyper- |
| | Based | | | | spherical |
| MuDi-Stream | Density | Online-offline | Damped | Auto | Arbitrary |
| | Based | | | | |
| CEDAS | Density | Online | Damped | Auto | Arbitrary |
| | Based | | | | |
| Improved Data | Density | Online-offline | Damped | Auto | Arbitrary |
| Stream Clustering | Based | | | | |
| DBIECM | Distance | Online | None | Auto | Hyper- |
| | Based | | | | spherical |
| I-HASTREAM | Density | Online-offline | Damped | Auto | Arbitrary |
| | Based | | | | |

The systems included in Table 1 can be broken down into three basic types: partition-, density-, and distance-based systems. The system 200, and corresponding functionalities, detailed herein is distance-based, but it distinguishes itself from DBIECM (the other distance-based system), by not relying on a predetermined distance threshold. While DBIECM is restricted to only creating clusters of one size, system 200 dynamically and automatically calculates and changes its distance threshold based on the data being analyzed at a particular point in time. Generally, partition-based systems rely on a predetermined k value—i.e., the number of clusters present in the data—and have difficulty handling concept drift. This is obviously problematic for streaming data where the number and positioning of clusters can change. The two partition-based systems in the above table, Adaptive Streaming k-Means and FEAC-Stream, attempt to overcome these limitations by dynamically adjusting their k value to account for cluster changes but they are still limited to hyper-spherical clusters due to the nature of a k-means approach. Density-based systems create micro-clusters of data points which are close together, these micro-clusters are summarized and aggregated with other micro-clusters that are within a certain distance. This approach generally relies on a predefined, static density threshold which means that this approach does not work well with clusters of varying densities. MuDi-Stream and I-HASTREAM both attempt to overcome this shortcoming by varying the density threshold of each cluster.

The column Phases of Table 1 refers to whether the classification occurs in real time with the streaming data or if there is an offline phase executed periodically that generates the final clustering of the data. An online-offline system by definition creates a significant latency between data ingestion and result output, so a fully online system is desirable. MuDi-Stream, Improved Data Stream Clustering, and I-HASTREAM all operate in an online-offline modality. These three systems are all density-based and follow the same basic online-offline workflow. In their online phase, micro-clusters are formed, and in the offline phase, those micro-clusters are formed into full clusters. The system described in this document is mostly online, meaning that as data is streamed in, it is immediately categorized according to existing clusters, and these results are delivered in real time. The caveat being that new clusters are created offline so there is some latency between a new cluster appearing in the data and that new cluster being added to the system.

The other systems included in this comparison, apart from DBIECM, employ windowing techniques to look at a sampling of the data stream all at once, the system described in this document does not need to use a windowing technique. No windowing means that the entirety of the data stream will be present in the final clustering (in the case of the novel approach, either as a part of a cluster or an outlier). The reason this novel system does not need to use a windowing technique is that each incoming point is tested against all existing clusters individually. It is only when enough outliers are accumulated that the data is looked at as a group to create a new cluster.

All the systems can automatically add clusters as they appear in the data.

The system described herein creates clusters with arbitrary and concave shapes. Adaptive Streaming k-Means, FEAC-Stream, and DBIECM can only create hyper-spherical clusters and cannot form arbitrary, concave clusters. The ability to create arbitrarily shaped clusters is potentially crucial if a particular feature of a cluster has an abnormal distribution.

Turning now to Table 2, additional metrics for comparison between the disclosed system 200 and other systems are shown.

TABLE 2
Comparison of Data Streaming Classification Methods.

| | Multi | | | | |
|---|---|---|---|---|---|
| | Density | High | Outlier | Drift | Expert |
| System | Clusters | Dimensional Data | Detection | Adaption | Knowledge |
| System 200 | Yes | Suitable | Yes | Yes | No |
| Adaptive Streaming | Yes | Suitable | No | Yes | No |
| k-Means | | | | | |
| FEAC-Stream | Yes | Suitable | Yes | Yes | Required |
| MuDi-Stream | Yes | Not Suitable | Yes | Yes | Required |
| CEDAS | No | Suitable | Yes | Yes | Required |
| Improved Data | No | Suitable | Yes | Yes | No |
| Stream Clustering | | | | | |
| DBIECM | Yes (not | Suitable | No | Yes | Required |
| | multi | | | | |
| | sized) | | | | |
| I-HASTREAM | Yes | Suitable | Yes | Yes | No |

The system described herein can detect clusters with varying densities. CEDAS and Improved Data Stream Clustering can only detect clusters that meet a constant density threshold and therefore cannot adjust if the nature of the data changes and that threshold no longer detects new clusters. The other distance-based system, DBIECM, can find clusters with varying densities but it is limited to a predefined radius and thus cannot find clusters of varying size. The system described in this document can find clusters of varying size.

None of the exemplary means/methods employed by the system 200 are limited in dimension, so the system as a whole is extensible to n-dimensions and suitable for high dimensional data. MuDi-Stream's processing time is very sensitive to the dimensionality of the data and so it is not suitable for higher dimensional data.

The disclosed system was invented specifically for handling noisy data; it can detect outliers and categorize data points as not being a part of an existing cluster. Adaptive Streaming k-Means and DBIECM are both unable to detect outliers. Every data instance is not forced into a cluster with the disclosed system, so this approach does not share the same shortcoming.

The system described in this document can adapt to concept drift and thus change without being brittle. Clusters are formed dynamically so a cluster consisting of a previously unseen feature set will be detected and categorized, and once created, clusters are not forgotten. A cluster that comes and goes, as illustrated by recurring drift, will not be problematic for this system. Finally, in the case of an incrementally drifting cluster, as a feature set leaves an existing cluster, this system allows for a new neighboring cluster to form following the drift of that feature set. These neighboring clusters can then, if desired by the user, be merged in the second pass portion of the system.

The disclosed system does not require expert knowledge but is able to incorporate any leverageable knowledge the user may have at various points in the system. FEAC-Stream, MuDi-Stream, CEDAS and DBIECM are all dependent on various hyper-parameters. In order for these systems to cluster effectively these parameters require expert knowledge about the data being processed.

The system described in this document provides a new and novel approach to data classification. It is designed to process streaming data without needing any a priori knowledge about the data stream and is capable of dynamically creating new category types and identifying noise in the data stream. Other systems that attempt to accomplish this same task fall short in one or more areas as shown in the tables above.

### REFERENCES

De Loera, J., Rambau, J., and Leal, F., (2003), Triangulations of Point Sets, https://personales.unican.es/santosf/MSRI03/chapterl.pdf
Zubaroglu, A. and Atalay, V., (2020), Data Stream Clustering: A Review, https://doi.org/10.48550/arXiv.2007.10781

I claim:

1. A real-time data categorization system for dynamically categorizing streaming data output from a data collection system, wherein said categorization system has no initial knowledge of a plurality of data categories to which ones of said data in said streaming data can be assigned, each of said plurality of data categories associated with a data cluster, comprising:
means for checking each one of said data, as received, against any known data categories and, if said one of said data fits one or more of said known data categories, classifying said one of said data according to said one or more of said known data categories, otherwise adding said one of said data to a pool of unclassified data;
means for, when said pool of unclassified data reaches a threshold, executing an unsupervised clustering method on said pool to identify any previously uncategorized clusters of data and define one or more new data categories for any such previously uncategorized clusters;
means for, if a new data category is defined for a previously uncategorized cluster of data, using each of said previously uncategorized clusters to define a shell for which previously unclassified data can be checked for inclusion and assigning any such unclassified data within said shell to said new data category; and,
outputting said categorized data to a data analysis system.

2. The system recited in claim 1, wherein said shell is defined by an equation in spherical coordinates, and inclusion of data within said shell is determined as a function of evaluating the equation for each of said unclassified data to determine if its location is within the radius defined by the equation.

3. The system recited in claim 1, wherein said shell is defined by a closed surface and inclusion of data within said shell is determined as a function of whether the location of said data is within said closed surface.

4. The system recited in claim 1, further comprising means for generating a representative group of points for said shell that occupies a spatial region that encompasses said previously uncategorized cluster.

5. The system recited in claim 4, wherein said means for generating a representative group of points utilizes vector quantization.

6. The system recited in claim 5, further comprising means for determining one or more distance thresholds that are a function of the relative spacing between ones of said representative group of points and the previously unclassified data within the shell.

7. The system recited in claim 6, wherein ones of said previously unclassified data are determined to be within said shell if a distance between any such data and each of the points comprising said representative group of points is within a threshold associated with each of said points comprising said representative group of points.

8. The system recited in claim 1, further comprising means for performing a second characterization pass on said streaming data, said second characterization pass operative to reevaluate any newly-identified clusters and the inclusion of any of said data therein.

9. The system recited in claim 8, wherein said second characterization pass is performed periodically as said streaming data is received.

10. The system recited in claim 9, wherein said second characterization pass is performed subsequent to a streaming data collection period.

11. The system recited in claim 8, wherein said second characterization pass is further operative to merge neighboring clusters into one category or split clusters that contain at least two distinct data categories.

12. The system recited in claim 1, wherein said threshold is a function of the data rate of said streaming data.

13. The system recited in claim 12, wherein said threshold is further a function of a predefined temporal interval.

14. The system recited in claim 1, wherein said unsupervised clustering method utilizes Delaunay triangulation.

15. The system recited in claim 1, wherein said unsupervised clustering method utilizes a Parzen Window Density Estimation (PWDE) defined by the equation:
$$p ( x ) = \frac{1}{n} {\sum }_{i = 1}^{n} \frac{1}{V} ϕ ( \frac{{x}_{i} - x}{h} )$$
wherein ϕ is a window function, h is the window width, V is the volume of the window, n is the number of points in the data set, x is location at which the density estimation is evaluated at, and xᵢ are the points in the data set.

16. The system recited in claim 1, wherein said data collection system is associated with a radar system.

17. The system recited in claim 16, wherein said data analysis system is operative to utilize said categorized data to identify radar pulses.

18. A real-time data categorization method for dynamically categorizing streaming data output from a data collection system, wherein said categorization method has no initial knowledge of a plurality of data categories to which ones of said data in said streaming data can be assigned, each of said plurality of data categories associated with a data cluster, comprising the steps of:
checking each one of said data, as received, against any known data categories and, if said one of said data fits one or more of said known data categories, classifying said one of said data according to said one or more of said known data categories, otherwise adding said one of said data to a pool of unclassified data;
executing, when said pool of unclassified data reaches a threshold, an unsupervised clustering method on said pool to identify any previously uncategorized clusters of data and define one or more new data categories for any such previously uncategorized clusters;
using, if a new data category is defined for a previously uncategorized cluster of data, each of said previously uncategorized clusters to define a shell for which previously unclassified data can be checked for inclusion and assigning any such unclassified data within said shell to said new data category; and,
outputting said categorized data to a data analysis system.

19. The method recited in claim 18, wherein said shell is defined by an equation in spherical coordinates, and inclusion of data within said shell is determined as a function of evaluating the equation for each of said unclassified data to determine if its location is within the radius defined by the equation.

20. The method recited in claim 18, wherein said shell is defined by a closed surface and inclusion of data within said shell is determined as a function of whether the location of said data is within said closed surface.

21. The method recited in claim 18, further comprising the step of generating a representative group of points for said shell that occupies a spatial region that encompasses said previously uncategorized cluster.

22. The method recited in claim 21, wherein said step of generating a representative group of points utilizes vector quantization.

23. The method recited in claim 22, further comprising the step of determining one or more distance thresholds that are a function of the relative spacing between ones of said representative group of points and the previously unclassified data within the shell.

24. The method recited in claim 23, wherein ones of said previously unclassified data are determined to be within said shell if a distance between any such data and each of the points comprising said representative group of points is within a threshold associated with each of said points comprising said representative group of points.

25. The method recited in claim 18, further comprising the step of performing a second characterization pass on said streaming data, said second characterization pass operative to reevaluate any newly-identified clusters and the inclusion of any of said data therein.

26. The method recited in claim 25, wherein said second characterization pass is performed periodically as said streaming data is received.

27. The method recited in claim 26, wherein said second characterization pass is performed subsequent to a streaming data collection period.

28. The method recited in claim 25, wherein said second characterization pass is further operative to merge neighboring clusters into one category or split clusters that contain at least two distinct data categories.

29. The method recited in claim 18, wherein said threshold is a function of the data rate of said streaming data.

30. The method recited in claim 29, wherein said threshold is further a function of a predefined temporal interval.

31. The method recited in claim 18, wherein said unsupervised clustering method utilizes Delaunay triangulation.

32. The method recited in claim 18, wherein said unsupervised clustering method utilizes a Parzen Window Density Estimation (PWDE) defined by the equation:
$$p ( x ) = \frac{1}{n} {\sum }_{i = 1}^{n} \frac{1}{V} ϕ ( \frac{{x}_{i} - x}{h} )$$
wherein ϕ is a window function, h is the window width, V is the volume of the window, n is the number of points in the data set, x is location at which the density estimation is evaluated at, and xᵢ are the points in the data set.

33. The method recited in claim 18, wherein said data collection system is associated with a radar system.

34. The method recited in claim 33, wherein said data analysis system is operative to utilize said categorized data to identify radar pulses.
